(19) United States
(12) Patent Application Publication
(10) Pub. No.: US 2008/0051094 A1
(43) Pub. Date: Feb. 28, 2008

(54) SYSTEM AND METHOD FOR FACILITATING COMMUNICATIONS

(75) Inventors: Jussi Maki, Helsinki (FI); Mikko Hamalainen, Helsinki (FI)

Correspondence Address: MORGAN & FINNEGAN, L.L.P., 3 WORLD FINANCIAL CENTER, NEW YORK, NY, 10281-2101, US

(73) Assignee: NOKIA CORPORATION, Espoo (FI)

(21) Appl. No.: 11/466,839

(22) Filed: Aug. 24, 2006

(51) Int. Cl. H04Q 7/20

(52) U.S. Cl. 455/445

(57) ABSTRACT

Systems and methods applicable, for instance, in facilitating communications. A wireless node and/or other computer might, for example, have connectivity via a network, and/or might search for networks. The wireless node and/or other computer might, for instance, request that communications be diverted to one or more telephone numbers associated with one or more found networks, and/or might establish connectivity via one or more found networks.

### FIELD OF INVENTION

This invention relates to systems and methods for facilitating communications.

### BACKGROUND INFORMATION

In recent times, there has been an increase in communications using wireless nodes and/or other computers. For example, many users have increasingly come to prefer using their wireless nodes and/or other computers for communications over other ways of performing communications. Moreover, an increasing number of users have come to employ wireless nodes and/or other computers as their primary way of performing communications.

Accordingly, there may be interest in technologies that facilitate such use of wireless nodes and/or other computers.

### SUMMARY OF THE INVENTION

According to embodiments of the present invention, there are provided systems and methods applicable, for example, in facilitating communications.

A wireless node and/or other computer might, in various embodiments, have connectivity via a network, and/or might search for networks.

The wireless node and/or other computer might, in various embodiments, request that communications (e.g., telephone calls and/or messages) be diverted to one or more telephone numbers associated with one or more found networks, and/or might establish connectivity via one or more found networks.

### BRIEF DESCRIPTION OF THE DRAWINGS

FIG. 1 shows exemplary steps involved in wireless node and/or other computer operations according to various embodiments of the present invention.

FIG. 2 shows further exemplary steps involved in wireless node and/or other computer operations according to various embodiments of the present invention.

FIG. 3 shows still further exemplary steps involved in wireless node and/or other computer operations according to various embodiments of the present invention.

FIG. 4 shows exemplary steps involved in server and/or other computer operations according to various embodiments of the present invention.

FIG. 5 shows an exemplary computer.

FIG. 6 shows a further exemplary computer.

### DETAILED DESCRIPTION OF THE INVENTION

### General Operation

According to embodiments of the present invention, there are provided systems and methods applicable, for example, in facilitating communications.

A wireless node and/or other computer might, in various embodiments, have connectivity (e.g., telephonic connectivity) via a network. Such a network might, for example, be a cellular network.

The wireless node and/or other computer might, in various embodiments, search for networks (e.g., local area networks). Having found one or more networks, the wireless node and/or other computer might, in various embodiments, provide to one or more servers and/or other computers information (e.g., information regarding one or more found networks).

In various embodiments the wireless node and/or other computer might, perhaps subsequent to providing the information, receive information regarding one or more found networks. Such information might, in various embodiments, include one or more telephone numbers associated with one or more of the found networks and/or information employable in establishing connectivity via one or more of the found networks.

The wireless node and/or other computer might, in various embodiments, request that communications (e.g., telephone calls and/or messages) directed to one or more telephone numbers be diverted to one or more telephone numbers associated with one or more of the found networks. It is further noted that the wireless node and/or other computer might, in various embodiments, establish connectivity via one or more of the found networks.

Various aspects of the present invention will now be discussed in greater detail.

### Wireless Node and/or Other Computer Operations

According to various embodiments of the present invention, a wireless node and/or other computer might have connectivity (e.g., telephonic connectivity) via a network. Such a network might, for example, be a cellular network (e.g., a Global System for Mobile Communications (GSM) network or a Universal Mobile Telecommunications System (UMTS) network). Such connectivity might, for instance, involve the wireless node and/or other computer being able to perform outgoing communications and/or receive incoming communications via the network. For example, such connectivity might involve the wireless node and/or other computer being able to perform outgoing telephone calls and/or receive incoming telephone calls via the network. As another example, such connectivity might involve the wireless node and/or other computer being able to send and/or receive messages via the network. Such messages might, for instance, include Short Message Service (SMS) and/or Multimedia Messaging Service (MMS) messages.

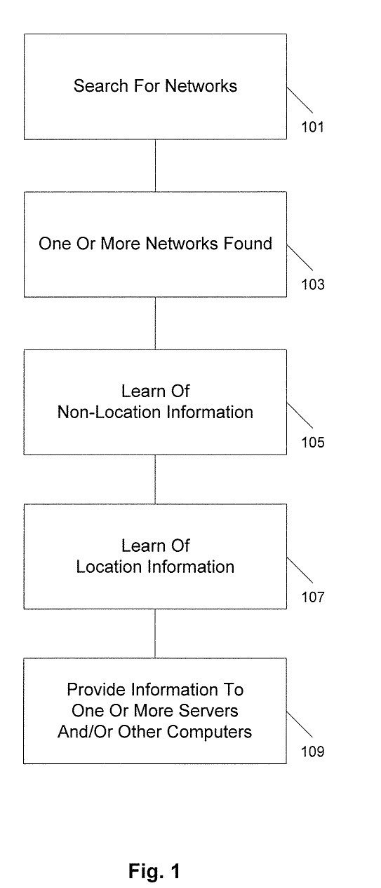

With respect to FIG. 1 it is noted that the wireless node and/or other computer might, for instance, search for networks (e.g., networks of one or more types) (step 101). For example, the wireless node and/or other computer might search for wireless local area networks. Such wireless local area networks might, for instance, be ones employing IEEE 802.11b. IEEE 802.11g, IEEE 802.11n, and/or Bluetooth (e.g., IEEE 802.15.1 Bluetooth). Such search might, for example, be done periodically. As another example, such search might be done constantly.

Performing such search, the wireless node and/or other computer might, for instance, come to find one or more networks (e.g., one or more wireless local area networks) (step 103). It is noted that, in various embodiments, the wireless node and/or other computer might consider itself to have come into range of one or more networks in the case where it finds one or more networks.

Having found one or more networks, the wireless node and/or other computer might, for instance, provide information regarding itself, its user, and/or found networks to one or more servers and/or other computers (step 109). Such information regarding found networks might, for instance, include one or more identifiers regarding the found networks and/or location information regarding the found networks. Such identifiers might, for example, include network names, network Service Set Identifiers (SSIDs), and/or network Media Access Control (MAC) addresses.

Such location information might, for example, include geographical information regarding network location (e.g., in terms of latitude-longitude coordinates) and/or relative location information (e.g., indication that a network is located at specified premises such as, for instance, a particular store, business, school, theater, and/or stadium).

The wireless node and/or other computer might, for instance, learn of non-location information (e.g., identifiers) regarding found networks (step 105) by communicating with those networks (e.g., via communication with one or more access points, servers, and/or other computers of found networks). Communication might, in various embodiments, involve Simple Object Access Protocol (SOAP), Java Messaging Service (JMS), Remote Method Invocation (RMI), Remote Procedure Call (RPC), sockets, and/or pipes. It is noted that, in various embodiments, broadcasts, made by found networks, conveying information (e.g., periodic broadcasts such as, for instance, IEEE 802.11 beacon packets) might be interpreted.

The wireless node and/or other computer might, for instance, learn of location information regarding found networks (step 107) by communicating with those networks (e.g., in a manner analogous to that just discussed), via use of Global Positioning System (GPS) hardware (e.g., hardware integrated with and/or in communication with the wireless node and/or other computer), via triangulation, via communication with one or more beacons (e.g., Bluetooth beacons), via Enhanced Observed Time Difference (E-OTD), and/or via location signature.

Provision of information to one or more servers and/or other computers by the wireless node and/or other computer regarding itself, its user, and/or found networks might be performed in a number of ways. For instance, the wireless node and/or other computer might perform such provision in a manner employing SOAP, JMS, RMI, RPC, sockets, and/or pipes. The wireless node and/or other computer might, for example, provide the information to the one or more servers and/or other computers via the network (e.g., a cellular network) via which the wireless node and/or other computer initially had connectivity as discussed above. As another example, the wireless node and/or other computer might, alternately or additionally, provide the information to the one or more servers and/or other computers via one or more of the found networks (e.g., via one or more wireless networks). It is noted that, in various embodiments, provision of such information by the wireless node and/or other computer might involve the use of the Internet and/or one or more Wide Area Networks (WANs).

It is noted that, in various embodiments, the one or more servers and/or other computers might be associated with one or more service providers. It is also noted that the one or more servers and/or other computers might, in various embodiments, be colocated with one or more of the found networks and/or be located apart from such found networks (e.g., at one or more central locations such as, for instance ones operated by one or more service providers such as, for example, cellular service providers).

The wireless node and/or other computer might learn of the one or more servers and/or other computers in a number of ways. For example, the wireless node and/or other computer might learn of the one or more servers and/or other computers via device discovery and/or service discovery. For instance, Bluetooth Device Discovery and/or Domain Name Server Service Discovery (DNS-SD) might be employed. As another example, the wireless node and/or other computer might learn of the one or more servers and/or other computers via a consultation of an accessible store. Such an accessible store might, for instance, be held locally and/or at be at a remote location.

The accessible store might, for example, be accessed in a manner analogous to that discussed above. Such a remote location might, for instance, be periodically updated. For example, an accessible store held by the wireless node and/or other computer might be periodically updated by communication (e.g., in a manner analogous to that discussed above) with one or remote locations (e.g., servers and/or other computers). Learning of the one or more servers and/or other computers might, for example, include learning of information employable in accessing those servers and/or other computers. Such information employable in access might, for instance, include one or more names (e.g., DNS names) and/or network addresses.

Subsequent to providing the information to the one or more servers and/or other computers, the wireless node and/or other computer might, for example, receive information (e.g., information regarding found networks) from the one or more servers and/or other computers. Provision of information by the one or more servers and/or other computers to the wireless node and/or other computer might, for instance, be performed in a manner analogous to that discussed above. For example, SOAP, JMS, RMI, RPC, sockets, and/or pipes might be employed, and/or provision might employ the network via which the wireless node and/or other computer initially had connectivity (e.g., a cellular network) and/or might employ one or more of the found networks (e.g., one or more wireless local area networks).

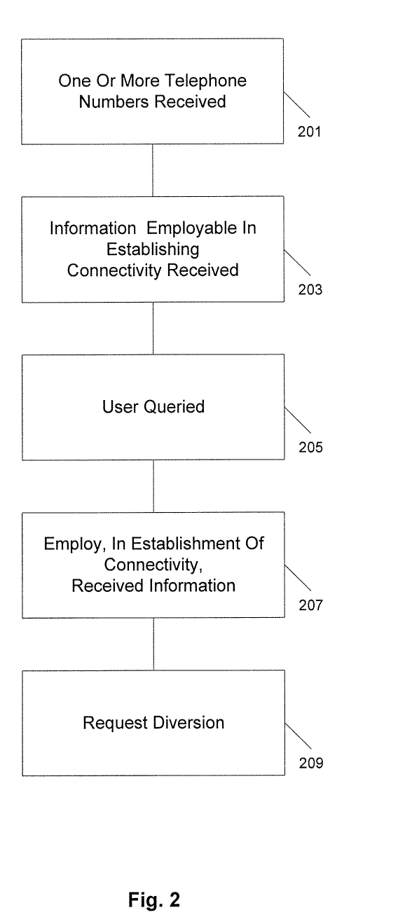

With respect to FIG. 2 it is noted that the information received by the wireless node and/or other computer from the one or more servers and/or other computers might, for example, include one or more telephone numbers associated with one or more of the found networks (step 201) and/or information employable in establishing connectivity via one or more of the found networks (step 203).

Such information employable in establishing connectivity via one or more of the found networks might, for example, include information employable in establishing Voice Over Internet Protocol (VOIP) connectivity. As another example, such information employable in establishing connectivity via one or more of the found networks might include information employable in establishing connectivity for messaging (e.g., SMS and/or MMS messaging). It is noted that, in various embodiments, found networks might be associated with one or more Private Branch Exchanges (PBXs). Such PBXs might, for instance, be corporate and/or hospitality (e.g., hotel and/or airport) PBXs.

It is additionally noted that, in various embodiments, the one or more telephone numbers received by the wireless node and/or other computer might include one or more telephone numbers corresponding to the wireless node and/or other computer, and/or to its user. Such a telephone number corresponding to the wireless node and/or other computer, and/or to its user might, for instance, be the user's business and/or hotel room telephone number. For instance, the wireless node and/or other computer might be a registered wireless node and/or other computer (e.g., registered with one or more found networks), and/or one or more found networks and/or associated PBXs might know of one or more telephone numbers that should be employed by the wireless node and/or other computer when the wireless node and/or other computer in having connectivity via those one or more networks. It is also noted that, in various embodiments, the one or more telephone numbers received by the wireless node and/or other computer might alternately or additionally include telephone numbers taken from a pool of available telephone numbers.

It is additionally noted that, in various embodiments, authentication of the wireless node and/or other computer, and/or its user, might be performed prior to information of the sort discussed above being provided to the wireless node and/or other computer. Such authentication might, for example, involve querying the wireless node and/or other computer, and/or its user, for one or more passwords, identifiers, biometric entries, and/or tokens. Such authentication might, for instance, be performed by the one or more servers and/or other computers that provide the information to the wireless node and/or other computer, and/or by one or more other servers and/or other computers.

The wireless node and/or other computer might, in various embodiments, query its user (e.g., via a Graphical User Interface (GUI), voice, audio, tactile, and/or other user interface) as to which one or more of the found networks should be selected for establishment of connectivity (step 205). The wireless node and/or other computer might, in various embodiments offer for selection by its user only those found networks for which information employable in establishing connectivity was received.

It is further noted that the wireless node and/or other computer might, for example, employ, in establishment of connectivity, the received information employable in establishing connectivity (step 207). For instance, the wireless node and/or other computer might employ such information with respect to found networks selected by the user of the wireless node and/or other computer. Establishment of connectivity via one or more of the found networks might, for instance, involve the wireless node and/or other computer communicating with one or more access points, servers, and/or other computers of those one or more found networks (e.g., with servers and/or other computers colocated with and/or remote from those found one or more networks).

It is noted that, in various embodiments, establishment of connectivity via a found network might involve authentication (e.g., of the sort discussed above) of the wireless node and/or other computer, and/or its user. Such authentication might, for example, be performed by the one or more access points, servers, and/or other computers with which the wireless node and/or other communicates in seeking to establish connectivity, and/or by one or more other access points, servers, and/or other computers.

Establishment of connectivity might, for example, result in the wireless node and/or other computer being able to perform outgoing communications and/or receive incoming communications via one or more found networks (e.g., via a wireless local area network). Such communications might, for instance, include messaging and/or telephone calls. It is further noted that establishment of connectivity via a found network might, for instance, involve establishment of connection with that network (e.g., establishment of a corresponding wireless local area network connection). It is additionally noted that, in various embodiments, establishment of connectivity via a chosen network might involve activation of Session Initiation Protocol (SIP) settings (e.g., to “always on”), and/or establishment of communication between a the wireless node and/or other computer and a server and/or other computer providing SIP proxy and/or gateway functionality.

The wireless node and/or other computer might, for instance, be able to perform outgoing communications and/or receive incoming communications via one or more telephone numbers associated with a found network via which connectivity has been established. For example, communications directed to such a telephone number might be received by the wireless node and/or other computer by way of a found network via which connectivity has been established, and/or communications originating at the wireless node and/or computer might be considered (e.g., by one or more networks) to have originated at such a telephone number.

It is noted that, in various embodiments, outgoing communications originating at the wireless node and/or other computer via or more telephone numbers associated with a found network via which connectivity has been established might not appear to recipients as having originated at such telephone numbers. For example, such a communication might appear to recipients (e.g., via caller identification) as having originated at a telephone number (e.g., a cellular telephone number) associated with a network via which the wireless node and/or other computer initially had connectivity (e.g., a cellular network).

The wireless node and/or other computer might, in various embodiments, request diversion of communications (e.g., messages and/or telephone calls) directed to one or more telephone numbers (e.g., cellular telephone numbers) associated with one or more networks via which the wireless node and/or other computer initially had connectivity (e.g., one or more cellular networks) to one or more telephone numbers associated with one or more found networks (e.g., wireless local area networks) (step 209). Such telephone numbers associated with one or more found networks might, for example, be telephone numbers via which the wireless node and/or other computer is able to receive incoming communications by way of one or more of the found networks.

Such functionality might be implemented in a number of ways. For instance, the wireless node and/or other computer might provide such request to one or more networks via which the wireless node and/or other computer initially had connectivity (e.g., one or more cellular networks). For example, the wireless node and/or other computer might communicate with one or more servers and/or other computers of such a network. It is noted that, in various embodiments, diversion might be performed by the network via which the wireless node and/or other computer initially had connectivity (e.g., a cellular network).

It is noted that, in various embodiments, in the case where the wireless node and/or other computer has multiple telephone numbers associated with one or more networks via which the wireless node and/or other computer initially had connectivity, communications directed to each such number might be directed to a different telephone number associated with a found network. To illustrate by way of example, in the case where the wireless node and/or other computer had two telephone numbers associated with a network via which it initially had connectivity (e.g., a cellular network), communications directed to a first of those telephone numbers might be diverted to one telephone number associated with a found network (e.g., a wireless local area network) and communications directed to a second of those telephone numbers might be diverted to another telephone number associated with that found network.

It is further noted that, in various embodiments, in the case where the wireless node and/or other computer has multiple telephone numbers associated with one or more networks via which the wireless node and/or other computer initially had connectivity, a single telephone number associated with a found network might receive diversion of communications directed to more than one telephone number associated with the one or more networks via which the wireless node and/or other computer initially had connectivity. To illustrate by way of example, in the case where the wireless node and/or other computer had two telephone numbers associated with a network via which it initially had connectivity (e.g., a cellular network), communications directed to both of those telephone numbers might be diverted to a single telephone number associated with a found network (e.g., a wireless local area network).

It is noted that, in various embodiments, having performed one or more of the operations discussed above, the wireless node and/or other computer might, for instance, be able to send and/or receive communications via a found network (e.g., a wireless local area network), and/or might receive via the found network redirected communications originally directed to one or telephone numbers associated with one or more networks via which the wireless node and/or other computer initially had connectivity (e.g., one or more cellular networks).

The wireless node and/or other computer might, in various embodiments, determine that one or more found networks, via which connectivity had been established, were no longer available. Such might, for instance, occur in the case where the wireless node and/or other computer had ceased to be in range of such networks. The wireless node and/or other computer might come to make such determination in a number of ways.

For example, the wireless node and/or other computer might recognize loss of connection to such a network. The wireless node and/or other computer might, in various embodiments, attempt to reconnect in the case that loss of connection was recognized, and might, for instance, only consider a found network, via which connectivity had been established, to no longer be available in the case where reconnection was not possible and/or where loss of connection persisted for greater than a particular period of time. Such a particular period of time might, for instance, be set by one or more users, network administrators, and/or manufacturers.

In the case where the wireless node and/or other computer determined a found network, via which connectivity had been established, to no longer be available, the wireless node and/or other computer might perform one or more operations. For example, the wireless node and/or other computer might act to see if one or more other networks were available. Such operations might, for instance, be performed in a manner analogous to that disused above with regard to searching for networks.

The wireless node and/or other computer might, for example, look for networks of the same type as and/or of a similar type to the one or more networks considered to be no longer available. To illustrate by way of example, in the case where a wireless local area network was considered to be no longer available, the wireless node and/or other computer might look for wireless local area networks.

As another example, the wireless node and/or other computer might look for networks of the same type as and/or of a similar type to one or more networks via which the wireless node and/or other computer initially had connectivity. To illustrate by way of example, in the case the wireless node and/or other computer initially had connectivity via a cellular network, the wireless node and/or other computer might look for that cellular network and/or for other cellular networks.

In various embodiments, in the case where the wireless node and/or other computer finds one or more networks of the same type as and/or of a similar type to the one or more networks considered to be no longer available, the wireless node and/or other computer might, for instance, act in a manner analogous to that disused above with respect to actions performed subsequent to finding one or more networks, the wireless node and/or other computer, in various embodiments, additionally requesting cessation of one or more previously-requested diversions.

In requesting such cessation the wireless node and/or other computer might, for example, communicate such request to the entity to which one or more corresponding diversion requests were provided. For instance, the wireless node and/or other computer might, perhaps in a manner analogous to that discussed above, communicate with the network via which the wireless node and/or other computer initially had connectivity (e.g., a cellular network).

In various embodiments, in the case where the wireless node and/or other computer finds one or more networks of the same type as and/or of a similar type to one or more networks via which the wireless node and/or other computer initially had connectivity, the wireless node and/or other computer might, for instance, perform one or more operations to establish and/or reestablish connectivity via one or more of those networks. Such operations might, for example, be performed in a manner analogous to that discussed above. Via such operations the wireless node and/or other computer might, for instance, come to be able to perform outgoing communications and/or receive incoming communications via one or more of those networks (e.g., via one or more cellular networks).

In various embodiments, roaming functionality might be employed. For instance, roaming functionality might be employed in the case where one or more found networks are of the same type as and/or of a similar type to one or more networks via which the wireless node and/or other computer initially had connectivity. It is further noted that, in various embodiments, the wireless node and/or other computer might, perhaps in a manner analogous to that discussed above, request cessation of one or more previously-requested diversions.

In various embodiments, in the case where the wireless node and/or other computer finds neither one or more networks of the same type as and/or of a similar type to the one or more networks considered to be no longer available, nor one or more networks of the same type as and/or of a similar type to one or more networks via which the wireless node and/or other computer initially had connectivity, the wireless node and/or other computer might perform one or more operations. For example, the wireless node and/or other computer might inform its user (e.g., via a GUI, voice, audio, tactile, and/or other user interface) that connectivity was not possible.

It is noted that, in various embodiments, the wireless node and/or other computer might be a multi-mode device (e.g., one capable of both cellular network telephony and wireless local area network telephony (e.g., using VOIP).

It is additionally noted that, in various embodiments, various operations discussed herein (e.g., establishment and/or reestablishment of connectivity via one or more networks, request of diversion, and/or request of diversion cessation) might involve the wireless node and/or other computer automatically changing one or more settings changeable by its user. Such functionality might, in various embodiments, involve the use of interprocess communication.

In various embodiments, the wireless node and/or other computer might be registered. For example, the wireless node and/or other computer might be registered with one or more found networks (e.g., wireless local area networks). The wireless node and/or other computer might be so registered for purposes such as, for instance, connectivity (e.g., connectivity employing VOIP).

As another example, the wireless node and/or other computer might be registered with one or more networks (e.g., cellular networks) via which the wireless node and/or other computer initially had connectivity. The wireless node and/or other computer might be so registered for purposes such as, for instance, connectivity. It is noted that, in various embodiments, in the case where the wireless node and/or other computer has connectivity via one or more found networks (e.g., wireless local area networks), the wireless node and/or other computer might remain registered with, but not be active with respect to, one or more networks (e.g., cellular networks) via which the wireless node and/or other computer initially had connectivity.

According to various embodiments of the present invention, one or more networks (e.g., networks found by the wireless node and/or other computer such as, for instance, wireless local area networks) might have remote and/or local access to one or more business connectivity servers and/or other computers (e.g., one or more Nokia Local Business Connectivity Solution servers and/or other computers), and/or the wireless node and/or other computer might be able to interface with one or more such servers and/or other computers.

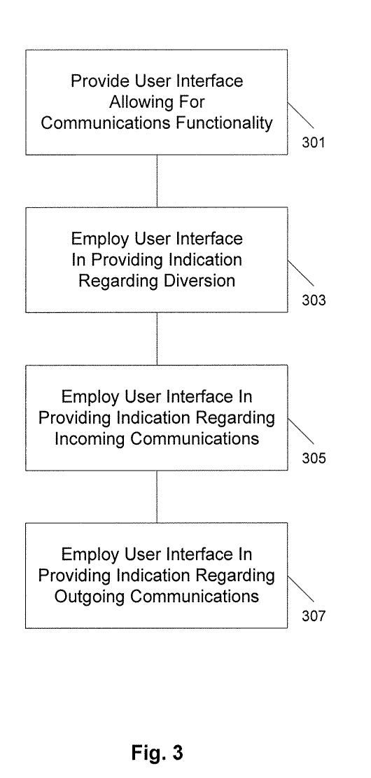

The wireless node and/or other computer might, in various embodiments, perform one or more operations relating to providing user interface (e.g., GUI, voice, audio, tactile, and/or other user interface). With respect to FIG. 3 it is noted that such provided user interface might, for instance, allow for communications functionality (step 301). Such communications might, for instance, include messaging functionality (e.g., sending and/or receiving messages) and/or telephone call functionality (e.g., making and/or receiving telephone calls).

Alternately or additionally, such provided user interface might, for instance, allow the wireless node and/or other computer to interact with its user regarding various operations discussed herein. For example, the wireless node and/or other computer might employ such user interface to indicate to its user that diversion (e.g., of the sort discussed above) had been requested, and/or that diversion (e.g., of the sort discussed above) was being and/or would be performed (step 303). As another example, the wireless node and/or other computer might employ such user interface to indicate to its user that incoming communications were being and/or would be handled via one or more found networks (e.g., one or more wireless local area networks) (step 305). As yet another example, the wireless node and/or other computer might employ such interface to indicate to its user that outgoing communications were being and/or would be handled via one or more found networks (e.g., one or more wireless local area networks) (step 307). Moreover, such provided user interface might, for instance, alternately or additionally allow users to perform one or more operations (e.g., to provide information and/or to make requests).

It is noted that, in various embodiments, a network (e.g., a wireless local area network and/or a cellular network) via which the node and/or other computer has connectivity might provide for Internet telephone calls (e.g., Internet telephone calls employing VOIP).

### Server and/or Other Computer Operations

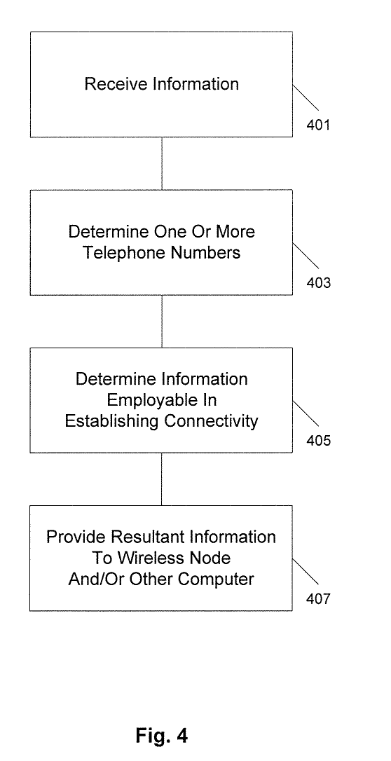

With respect to FIG. 4 it is noted that, according to various embodiments of the present invention, one or more servers and/or other computers might, for example, receive information of the sort discussed above dispatched by a wireless node and/or other computer as discussed above (step 401). Accordingly, for instance, such a server and/or other computer might receive, from a wireless node and/or other computer that has found one or more networks, information regarding the wireless node and/or other computer, the user of the wireless node and/or other computer, and/or networks found by the wireless node and/or other computer.

Such information might, for instance, be received by the server and/or other computer in a manner in accordance with that which is discussed above. For example, receipt might be via one or more cellular networks, via the Internet, and/or via one or more WANs, and/or might involve SOAP, JMS, RMI, RPC, sockets, and/or pipes.

The server and/or other computer might, for instance, employ, in performing one or more determinations, some or all of the information received from the wireless node and/or other computer. Such determinations might, for example, include determination of one or more telephone numbers associated with one or more found networks (e.g., wireless local area networks) (step 403), and/or determination of information employable in establishing connectivity via one or more found networks (e.g., wireless local area networks) (step 405).

Moreover, such determinations might, for instance, involve the server and/or other computer accessing local and/or remote resources (e.g., local and/or remote accessible stores such as, for instance, databases) that correlate network information (e.g., information of the sort discussed above such as, for instance, SSIDs) with information of the sort discussed above as being dispatched to wireless nodes and/or other computers (e.g., phone numbers associated with networks, and/or information employable in establishing connectivity via networks).

It is noted that, in various embodiments, determination performed by the server and/or other computer might include determining whether or not one or more networks found by the wireless node and/or other computer are managed networks and/or participating networks (e.g., networks whose owners have agreed to allow wireless nodes and/or other computers to make use of the networks as disused herein).

Having performed such one or more determinations, the server and/or other computer might, for instance, provide resultant information to the wireless node and/or other computer (step 407). Such provision might, for instance, trigger the wireless node and/or other computer to perform one or more of the operations discussed above (e.g., establishment of connectivity via one or more found networks and/or request of diversion).

Such provision, might, for example, involve the use of one or more cellular networks, the Internet, and/or one or more WANs, and/or involve the use of one or more networks via which the wireless node and/or other computer initially had connectivity and/or one or more of the networks found by the wireless node and/or other computer (e.g., one or more wireless local area networks). It is further noted that such provision might, for instance, involve the use of SOAP, JMS, RMI, RPC, sockets, and/or pipes.

It is noted that, in various embodiments, one or more operations discussed herein as being performed by a wireless node and/or other computer might, alternatively or additionally, be performed by the server and/or other computer. For example, one or more of the operations relating to diversion discussed herein (e.g., operations regarding request of diversion and/or operations regarding request of cessation of diversion) might, as an alterative to and/or in addition to being performed by the wireless node and/or other computer, be performed by the server and/or other computer. For instance, the server and/or other computer might, perhaps in a manner analogous to that discussed above, communicate with one or more networks via which the wireless node and/or other computer initially had connectivity.

Moreover, it is noted that, in various embodiments, there may be communication between the server and/or other computer and one or more Mobile Switching Center (MSCs) and/or Home Location Registers (HLRs). Such MSCs and/or HLRs might, for instance, be associated with one or more networks via which the wireless node and/or other computer initially had connectivity (e.g., one or more cellular networks).

It is also noted that, in various embodiments, there might be communication between the server and/or other computer and one or more messaging centers (e.g., one or more Short Message Service Centers (SMSCs)). Such communication might, for example, involve the server and/or other computer receiving messages (e.g., SMS and/or MMS messages) directed to one or more telephone numbers associated with one or more networks (e.g., one or more found networks). As another example, such communication might involve the server and/or other computer sending messages (e.g., SMS and/or MMS messages) that originated at the wireless node and/or other computer. Communication between the server and/or other computer and the one or more messaging centers might, for instance, involve one or more of the communication modalities discussed herein (e.g., SOAP might be employed).

Receiving such a message the server and/or other computer might, for instance, provide the message to the wireless node and/or other computer (e.g., via a found network such as a wireless local area network). Such provision might, for instance, involve communication modalities of the sort discussed herein (e.g., SOAP might be employed). The wireless node and/or other computer might, in various embodiments, present the message to the user (e.g., via a GUI and/or other interface). Message sending might, for instance, involve the server and/or other computer receiving the message from the wireless node and/or other computer (e.g., via software of the wireless node and/or other computer). Such receiving might, for instance, involve communication modalities of the sort discussed herein (e.g., SOAP might be employed). The wireless node and/or other computer might, in various embodiments, provide for the creation of the message by the user (e.g., via a GUI and/or other interface).

In various embodiments, the server and/or other computer might receive such a message from, and/or send such a message to, other than a messaging center and/or without being in communication with a messaging center. For instance, the serer and/or other computer might receive and/or send such a message directly, and/or might perform one or more messaging center operations.

It is noted that, in various embodiments, the server and/or other computer might be capable of VOIP, SIP, and/or PBX operations. It is additionally noted that, in various embodiments, one or more of the operations discussed herein as being performed by the server and/or other computer might be performed by one or more service providers, and/or the server and/or other computer might be associated with one or more service providers. It is also noted that, in various embodiments, functionality analogous to that discussed herein might be provided with respect to data communications, chat, and/or instant messaging.

### Hardware and Software

Various operations and/or the like described herein may, in various embodiments, be executed by and/or with the help of computers. Further, for example, devices described herein may be and/or may incorporate computers. The phrases “computer”, “general purpose computer”, and the like, as used herein, refer but are not limited to a smart card, a media device, a personal computer, an engineering workstation, a PC, a Macintosh, a PDA, a portable computer, a computerized watch, a wired or wireless terminal, telephone, communication device, node, and/or the like, a server, a network access point, a network multicast point, a network device, a set-top box, a personal video recorder (PVR), a game console, a portable game device, a portable audio device, a portable media device, a portable video device, a television, a digital camera, a digital camcorder, a Global Positioning System (GPS) receiver, a wireless personal server, or the like, or any combination thereof, perhaps running an operating system such as OS X, Linux, Darwin, Windows CE, Windows XP, Windows Server 2003, Palm OS, Symbian OS, or the like, perhaps employing the Series 40 Platform, Series 60 Platform, Series 80 Platform, and/or Series 90 Platform, and perhaps having support for Java and/or .Net.

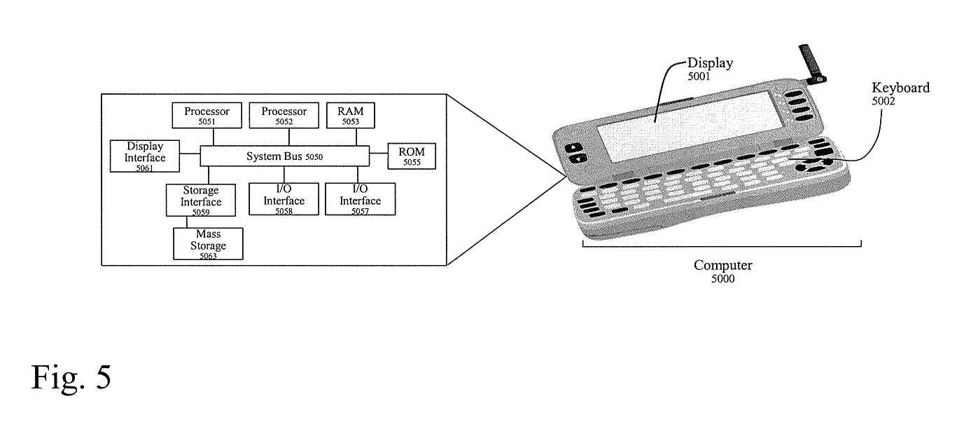

The phrases “general purpose computer”, “computer”, and the like also refer, but are not limited to, one or more processors operatively connected to one or more memory or storage units, wherein the memory or storage may contain data, algorithms, and/or program code, and the processor or processors may execute the program code and/or manipulate the program code, data, and/or algorithms. Shown in FIG. 5 is an exemplary computer employable in various embodiments of the present invention. Exemplary computer 5000 includes system bus 5050 which operatively connects two processors 5051 and 5052, random access memory 5053, read-only memory 5055, input output (I/O) interfaces 5057 and 5058, storage interface 5059, and display interface 5061. Storage interface 5059 in turn connects to mass storage 5063. Each of I/O interfaces 5057 and 5058 may, for example, be an Ethernet, IEEE 1394, IEEE 1394b, IEEE 802.11a, IEEE 802.11b, IEEE 802.11g, IEEE 802.11i, IEEE 802.11e, IEEE 802.11n, IEEE 802.15a, IEEE 802.16a, IEEE 802.16d, IEEE 802.16e, IEEE 802.16x, IEEE 802.20, IEEE 802.15.3, ZigBee (e.g., IEEE 802.15.4), Bluetooth (e.g., IEEE 802.15.1), Ultra Wide Band (UWB), Wireless Universal Serial Bus (WUSB), wireless Firewire, terrestrial digital video broadcast (DVB-T), satellite digital video broadcast (DVB-S), Advanced Television Systems Committee (ATSC), Integrated Services Digital Broadcasting (ISDB), Digital Multimedia Broadcast-Terrestrial (DMB-T), MediaFLO (Forward Link Only), Terrestrial Digital Multimedia Broadcasting (T-DMB), Digital Audio Broadcast (DAB), Digital Radio Mondiale (DRM), General Packet Radio Service (GPRS), Universal Mobile Telecommunications Service (UMTS), Global System for Mobile Communications (GSM), Code Division Multiple Access 2000 (CDMA2000), DVB-H (Digital Video Broadcasting: Handhelds), IrDA (Infrared Data Association), and/or other interface.

Mass storage 5063 may be a hard drive, optical drive, a memory chip, or the like. Processors 5051 and 5052 may each be a commonly known processor such as an IBM or Freescale PowerPC, an AMD Athlon, an AMD Opteron, an Intel ARM, an Intel XScale, a Transmeta Crusoe, a Transmeta Efficeon, an Intel Xenon, an Intel Itanium, an Intel Pentium, an Intel Core, or an IBM, Toshiba, or Sony Cell processor. Computer 5000 as shown in this example also includes a touch screen 5001 and a keyboard 5002. In various embodiments, a mouse, keypad, and/or interface might alternately or additionally be employed. Computer 5000 may additionally include or be attached to card readers, DVD drives, floppy disk drives, hard drives, memory cards, ROM, and/or the like whereby media containing program code (e.g., for performing various operations and/or the like described herein) may be inserted for the purpose of loading the code onto the computer.

In accordance with various embodiments of the present invention, a computer may run one or more software modules designed to perform one or more of the above-described operations. Such modules might, for example, be programmed using languages such as Java, Objective C, C, C#, C++, Perl, Python, and/or Comega according to methods known in the art. Corresponding program code might be placed on media such as, for example, DVD, CD-ROM, memory card, and/or floppy disk. It is noted that any described division of operations among particular software modules is for purposes of illustration, and that alternate divisions of operation may be employed. Accordingly, any operations discussed as being performed by one software module might instead be performed by a plurality of software modules. Similarly, any operations discussed as being performed by a plurality of modules might instead be performed by a single module. It is noted that operations disclosed as being performed by a particular computer might instead be performed by a plurality of computers. It is further noted that, in various embodiments, peer-to-peer and/or grid computing techniques may be employed. It is additionally noted that, in various embodiments, remote communication among software modules may occur. Such remote communication might, for example, involve Simple Object Access Protocol (SOAP), Java Messaging Service (JMS), Remote Method Invocation (RMI), Remote Procedure Call (RPC), sockets, and/or pipes.

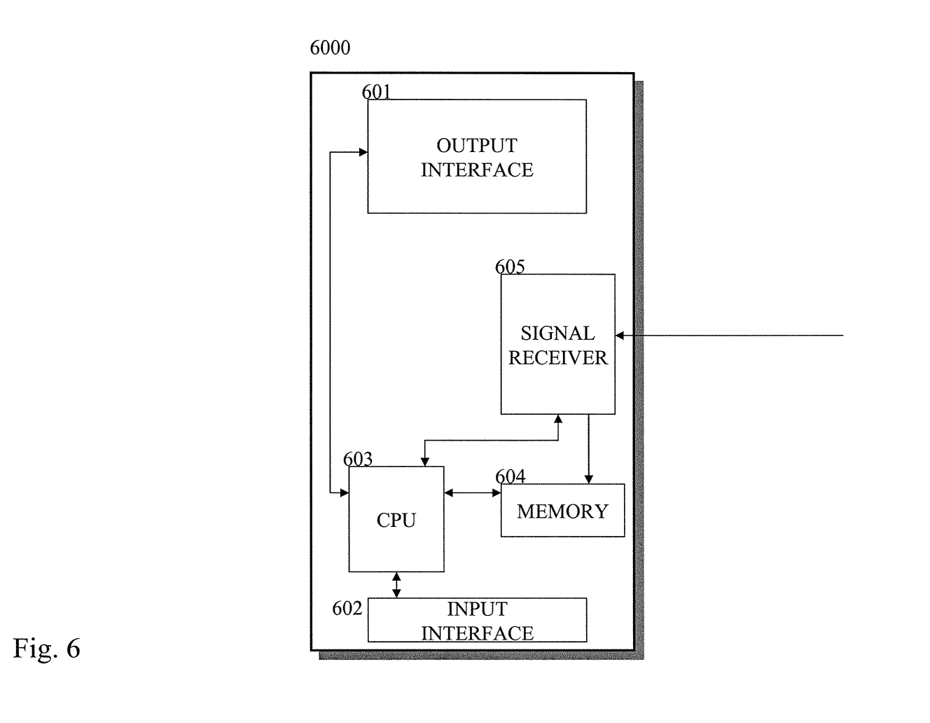

Shown in FIG. 6 is a block diagram of a terminal, an exemplary computer employable in various embodiments of the present invention. In the following, corresponding reference signs are applied to corresponding parts. Exemplary terminal 6000 of FIG. 6 comprises a processing unit CPU 603, a signal receiver 605, and a user interface (601, 602). Signal receiver 605 may, for example, be a single-carrier or multi-carrier receiver. Signal receiver 605 and the user interface (601, 602) are coupled with the processing unit CPU 603. One or more direct memory access (DMA) channels may exist between multi-carrier signal terminal part 605 and memory 604. The user interface (601, 602) comprises a display and a keyboard to enable a user to use the terminal 6000. In addition, the user interface (601, 602) comprises a microphone and a speaker for receiving and producing audio signals. The user interface (601, 602) may also comprise voice recognition (not shown).

The processing unit CPU 603 comprises a microprocessor (not shown), memory 604, and possibly software. The software can be stored in the memory 604. The microprocessor controls, on the basis of the software, the operation of the terminal 6000, such as receiving of a data stream, tolerance of the impulse burst noise in data reception, displaying output in the user interface and the reading of inputs received from the user interface. The hardware contains circuitry for detecting signal, circuitry for demodulation, circuitry for detecting impulse, circuitry for blanking those samples of the symbol where significant amount of impulse noise is present, circuitry for calculating estimates, and circuitry for performing the corrections of the corrupted data.

Still referring to FIG. 6, alternatively, middleware or software implementation can be applied. The terminal 6000 can, for instance, be a hand-held device which a user can comfortably carry. The terminal 6000 can, for example, be a cellular mobile phone which comprises the multi-carrier signal terminal part 605 for receiving multicast transmission streams. Therefore, the terminal 6000 may possibly interact with the service providers.

It is noted that various operations and/or the like described herein may, in various embodiments, be implemented in hardware (e.g., via one or more integrated circuits). For instance, in various embodiments various operations and/or the like described herein may be performed by specialized hardware, and/or otherwise not by one or more general purpose processors. One or more chips and/or chipsets might, in various embodiments, be employed. In various embodiments, one or more Application-Specific Integrated Circuits (ASICs) may be employed.

### Ramifications and Scope

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention.

In addition, the embodiments, features, methods, systems, and details of the invention that are described above in the application may be combined separately or in any combination to create or describe new embodiments of the invention.

What is claimed is:

1. A method, comprising:
dispatching information regarding a wireless local area network;
receiving one or more telephone numbers associated with the wireless local area network; and
providing, to a cellular network, request that communications directed to one or more cellular telephone numbers be diverted to one or more of the telephone numbers associated with the wireless local area network.

2. The method of claim 1, further comprising performing outgoing communications via the wireless local area network.

3. The method of claim 1, further comprising receiving information employable in establishing connectivity via the wireless local area network.

4. The method of claim 1, wherein the communications are telephone calls.

5. The method of claim 1, wherein the communications are messages.

6. The method of claim 1, wherein the information regarding the wireless local area network comprises one or more identifiers.

7. The method of claim 1, wherein the information regarding the wireless local area network comprises location information.

8. The method of claim 1, further comprising providing, to the cellular network, request to cease diverting.

9. A method, comprising:
receiving, from a wireless node, information regarding a wireless local area network;
determining one or more telephone numbers associated with the wireless local area network; and
triggering the wireless node to provide to a cellular network request that communications directed to one or more cellular telephone numbers be diverted to one or more of the telephone numbers associated with the wireless local area network.

10. The method of claim 9, further comprising determining information employable in establishing connectivity via the wireless local area network.

11. The method of claim 9, further comprising dispatching, to the wireless node, information employable in establishing connectivity via the wireless local area network.

12. The method of claim 9, wherein the communications are telephone calls.

13. The method of claim 9, wherein the communications are messages.

14. The method of claim 9, wherein the information regarding the wireless local area network comprises one or more identifiers.

15. The method of claim 9, wherein the information regarding the wireless local area network comprises location information.

16. The method of claim 9, further comprising performing authentication.

17. A method, comprising:
providing a user interface employable in communications functionality;
providing, via a user interface, indication that communications directed to one or more cellular telephone numbers will be diverted to one or more telephone numbers associated with a wireless local area network; and
providing, via a user interface, indication that outgoing communications will be performed via the wireless local area network.

18. A method, comprising:
receiving at a service provider, from a wireless node, information regarding a wireless local area network;
determining, at the service provider, one or more telephone numbers associated with the wireless local area network; and
triggering, at the service provider, the wireless node to provide to a cellular network request that communications directed to one or more cellular telephone numbers be diverted to one or more of the telephone numbers associated with the wireless local area network.

19. An apparatus, comprising:
a memory having program code stored therein; and
a processor disposed in communication with the memory for carrying out instructions in accordance with the stored program code;
wherein the program code, when executed by the processor, causes the processor to perform:
dispatching information regarding a wireless local area network;
receiving one or more telephone numbers associated with the wireless local area network; and
providing, to a cellular network, request that communications directed to one or more cellular telephone numbers be diverted to one or more of the telephone numbers associated with the wireless local area network.

20. The apparatus of claim 19, wherein the processor further performs:
receiving information employable in establishing connectivity via the wireless local area network.

21. The apparatus of claim 19, wherein the communications are telephone calls.

22. The apparatus of claim 19, wherein the communications are messages.

23. The apparatus of claim 19, wherein the information regarding the wireless local area network comprises one or more identifiers.

24. The apparatus of claim 19, wherein the information regarding the wireless local area network comprises location information.

25. The apparatus of claim 19, wherein the processor further performs:
providing, to the cellular network, request to cease diverting.

26. The apparatus of claim 19, further comprising:
a network interface disposed in communication with the processor,
wherein the apparatus is a wireless node.

27. An apparatus, comprising:
a memory having program code stored therein; and
a processor disposed in communication with the memory for carrying out instructions in accordance with the stored program code;
wherein the program code, when executed by the processor, causes the processor to perform:
receiving, from a wireless node, information regarding a wireless local area network;
determining one or more telephone numbers associated with the wireless local area network; and
triggering the wireless node to provide to a cellular network request that communications directed to one or more cellular telephone numbers be diverted to one or more of the telephone numbers associated with the wireless local area network.

28. The apparatus of claim 27, wherein the processor further performs:
dispatching, to the wireless node, information employable in establishing connectivity via the wireless local area network.

29. The apparatus of claim 27, wherein the information regarding the wireless local area network comprises one or more identifiers.

30. The apparatus of claim 27, wherein the information regarding the wireless local area network comprises location information.

31. The apparatus of claim 27, further comprising:
a network interface disposed in communication with the processor,
wherein the apparatus is a wireless node.

32. An apparatus, comprising:
a memory having program code stored therein; and
a processor disposed in communication with the memory for carrying out instructions in accordance with the stored program code;
wherein the program code, when executed by the processor, causes the processor to perform:
providing a user interface employable in communications functionality;
providing, via a user interface, indication that communications directed to one or more cellular telephone numbers will be diverted to one or more telephone numbers associated with a wireless local area network; and
providing, via a user interface, indication that outgoing communications will be performed via the wireless local area network.

33. The apparatus of claim 32, further comprising:
a network interface disposed in communication with the processor,
wherein the apparatus is a wireless node.

34. An article of manufacture comprising a computer readable medium containing program code that when executed causes an apparatus to perform:
dispatching information regarding a wireless local area network;
receiving one or more telephone numbers associated with the wireless local area network; and
providing, to a cellular network, request that communications directed to one or more cellular telephone numbers be diverted to one or more of the telephone numbers associated with the wireless local area network.

35. An article of manufacture comprising a computer readable medium containing program code that when executed causes an apparatus to perform:
receiving, from a wireless node, information regarding a wireless local area network;
determining one or more telephone numbers associated with the wireless local area network; and
triggering the wireless node to provide to a cellular network request that communications directed to one or more cellular telephone numbers be diverted to one or more of the telephone numbers associated with the wireless local area network.

36. An article of manufacture comprising a computer readable medium containing program code that when executed causes an apparatus to perform:
providing a user interface employable in communications functionality;
providing, via a user interface, indication that communications directed to one or more cellular telephone numbers will be diverted to one or more telephone numbers associated with a wireless local area network; and
providing, via a user interface, indication that outgoing communications will be performed via the wireless local area network.
